(19) United States
(12) Patent Application Publication
(10) Pub. No.: US 2012/0157204 A1
(43) Pub. Date: Jun. 21, 2012

(54) USER-CONTROLLED PROJECTOR-BASED GAMES

(75) Inventors: Jeremy Kelsey, Auckland (NZ); Christopher J. McGrath, Wights Mountain (AU)

(73) Assignee: LAI Games Australia Pty Ltd., Northbridge (AU)

(21) Appl. No.: 12/973,528

(22) Filed: Dec. 20, 2010

(51) Int. Cl. G06F 17/00

(52) U.S. Cl. 463/34

(57) ABSTRACT

Projector-based amusement games are defined which detect the location attributes, such as position, motion, angle of direction, orientation, direction of aiming, and the like, imparted on the controller or controllers by a user. Signals representative of the detected location attributes are then used to determine the next states of the game. Visual images and animations representing a portion of the next states associated with the location attributes are generated and sent to be projected onto a projection surface. The one or more projectors used to project the visual images and animations may be embedded into the user controller or external to the user controller.

### CROSS-REFERENCE TO RELATED APPLICATIONS

Not applicable.

### TECHNICAL FIELD

The present disclosure relates, in general, to amusement gaming, and, more particularly, to user-controlled projector-based games.

### BACKGROUND

The game industry has evolved from early wooden games with mechanical operations to the most advanced computer-animated video games that use high definition graphics and sound, along with player input determined based on orientation positioning, motion detection, and even facial expression detection. Modern amusement games generally display the gaming field to the user via an electronic video display device. The movement and progression of the game, as presented on the electronic display device, is typically a result of receiving user input and using this input to calculate the game progression and corresponding visual/video images.

A user control device or controller is often used as the means for the user to provide game input whether the game is a home console video game or a cabinet-based arcade style game. Depending on the game content, the user often enters input by manipulating a joystick, a roller ball, buttons, triggers, and the like. The electronics coupled to the user control device reads or detects the type of input made and passes that information to the game logic, which uses the input to calculate the resulting game state, which is then rendered and presented to the user on the display device. For example, when manipulating an analog joystick, the underlying electronics of the joystick returns angle measurements of the movement in any direction in the plane or space often using electronic devices such as potentiometers. Based on these angle measurements, the underlying game logic calculates the resulting next state of the game.

Some user control devices have been configured to emit or detect information based on the user's positioning of the controller with respect to the game display. Light gun controllers have been implemented historically that emit light from a light source in the controller which triggers light detectors in mechanical game displays. For example, some target shooting arcade games use physical targets that are either stationary or moved across the physical game display. Each target of such games includes a light detector. Users aim the light gun at the target and pull the trigger to activate a pulse of light from the light gun. If the light detector embedded in the target detects the light emitted from the light gun, the target falls over indicating that the user successfully aimed the light gun. In this configuration of controller, light detectors are needed on the game display. Because modern video display devices generally do not include such detectors, this type of game and game controller was not directly convertible into electronic display-based gaming systems.

Target-styled games have often been adapted to such electronic display-based games using techniques, such as reversing the light gun configuration. Instead of requiring a light detector on the game display, light detectors are incorporated into the game controllers. One example of such a configuration is Nintendo Co., Ltd.'s Duck Hunt game for the Nintendo Entertainment System (NES™) game console. Duck Hunt uses the NES ZAPPER™ light gun controller. While referred to as a light gun, the NES ZAPPER™ is actually configured with a light detector. When a user pulls the trigger, the game causes the entire screen to become black for one frame. Then, on the next frame, the target area is drawn in all white as the rest of the screen remains black. The NES ZAPPER™ detects this change from low light to bright light using the light detector, as well as at which screen position the change was detected. Using this information, the game knows which target has been hit or not hit. After all target areas have been illuminated, the game returns to drawing graphics as usual. This entire process occurs in fractions of seconds. Therefore, it is generally imperceptible to the game player.

Another technique that is used in similar light-detector controllers is making the entire screen black in one frame and white in the next. Calculations for this transition are used to determine the position of the electron beam in a conventional cathode ray tube (CRT) display device. This technique works only on conventional CRT television sets, as such, modern plasma or liquid crystal display (LCD) screens are incompatible with this method.

Other targeting-type games use infrared (IR) detections systems to calculate the positioning between the controller and the game display. Such systems generally place various IR emitters at positions relative to the game display. The controllers of such game systems include IR detectors, such that the emitted IR signals are detected and analyzed using trigonometric positioning analysis to determine where the controller is located and/or aiming relative to the game display.

Many modern game systems are beginning to use even more complex orientation sensing and image capture and analysis techniques for obtaining user input. For example, Nintendo Co. Ltd.'s WII® game system uses a controller that contains a three-axis accelerometer to detect motion and orientation input. Moreover, the Sony Computer Entertainment's PLAYSTATION MOVE™ is a motion-sensing game controller that uses both inertial sensors in the controller and a camera coupled to the game console to track the motion and position of the controller. Based on these types of detected inputs, the game logic running on the respective game consoles determines the next state of the game display for presentation to the user on the display device.

### BRIEF SUMMARY

Representative embodiments of the present disclosure are directed to projector-based interactive games which detect location attributes of a user controller, such as position, motion, angle of direction, orientation and the like, imparted on the controller by a user, as well as other user interactions, including other user interactions with the user controller and game environment. Signals representative of the detected location attributes and interactions are then used to determine the next states of the interactive game. Visual images and animations representing the next game states are generated and sent to be projected onto a projection surface by a projector or projectors that are either embedded into the user controller or external thereto. Some or all of the resulting projected visual images and animations provide a special virtual viewport display of the created, programmed environment the game is being played in and provide detailed game actions and visual images associated with the actual location in the created, programmed game environment at which the user controller is pointing or aiming.

When the projector is embedded into the user controller, the detection and projection process continues throughout the user's play of the game, providing the virtual visual viewport with animation and visual images of the aimed-to/pointed-at portion of the game world of the game environment. When using an external projector or projectors the detection and projection process also continues throughout the user's play of the game, providing this virtual viewport with special animation and visual images of the aimed-to/pointed-at portion of the game world of the game environment as part of the fully-projected game environment. The overall affect gives the user a very strong realistic sense of really being placed in and interacting inside the created game environment.

Further representative embodiments of the present disclosure are directed to methods for a game. Such methods include detecting one or more location attributes of a user controller imparted on the user controller by a user, determining game progression of the game based at least in part on the detected location attributes, and projecting visual images, including images, animation objects, and the like, representative of a portion of the determined game progression associated with the location attributes.

Still further representative embodiments of the present disclosure are directed to computer program products for a game. The computer program products include a computer-readable medium having program code recorded thereon. This program code includes code to detect one or more location attributes of a user controller imparted on the user controller by a user, code to determine game progression of the game based at least in part on the detected location attributes, and code to project visual images, including images, animation objects, and the like, representative of a portion of the determined game progression associated with the location attributes.

Further representative embodiments of the present disclosure are directed to game apparatuses that include at least one processor and a memory coupled to the processor. Through various executable logic, whether in software, firmware, hardware, or some combination thereof, the processor is configured to detect one or more location attributes of a user controller imparted on the user controller by a user; to determine game progression of the game based at least in part on the detected location attributes; and to direct projection of visual images representative of a portion of the determined game progression associated with the location attributes, where the user controller is at least a part of the game apparatus.

The foregoing has outlined rather broadly the features and technical advantages of the present disclosure in order that the detailed description that follows may be better understood. Additional features and advantages will be described hereinafter which form the subject of the claims of this disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the present disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawing, in which:

FIG. 1 is a block diagram illustrating a projector-based game system configured according to one embodiment of the present disclosure.

FIG. 2 is a block diagram illustrating a projector game system configured according to one embodiment of the present disclosure.

FIG. 3 is a block diagram illustrating an amusement game configured according to one embodiment of the present disclosure.

FIG. 4 is a block diagram illustrating an amusement game configured according to one embodiment of the present disclosure.

FIG. 5 is a block diagram illustrating a display screen displaying an animation of a projector-based game configured according to one embodiment of the present disclosure.

FIG. 6 is a block diagram illustrating a computing device configured according to one embodiment of the present disclosure.

FIG. 7A is a block diagram illustrating a user controller configured according to one embodiment of the present disclosure.

FIG. 7B is a block diagram illustrating a user controller configured according to one embodiment of the present disclosure.

FIG. 8 is a block diagram illustrating a projector-based amusement game configured according to one embodiment of the present disclosure.

FIG. 9A is a functional block diagram illustrating example blocks executed to implement one embodiment of the present disclosure.

FIG. 9B is a functional block diagram illustrating example blocks executed to implement another embodiment of the present disclosure.

FIG. 10 is a block diagram illustrating user controllers configured in a projector-based game according to one embodiment of the present disclosure.

FIGS. 11A-11C are conceptual block diagrams illustrating a sequence of game play within a projector-based game configured according to one embodiment of the present disclosure.

FIG. 12 illustrates an exemplary computer system which may be employed to implement the various aspects and embodiments of the present disclosure.

### DETAILED DESCRIPTION

In the detailed description below, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter. Some portions of the detailed description may be presented in terms of algorithms or symbolic representations of operations on data bits or binary digital signals stored within a computing system memory, such as a computer memory. These algorithmic descriptions or representations are examples of techniques used by those of ordinary skill in the art to convey the substance of their work to others skilled in the art.

An algorithm is here, and generally, considered to be a self-consistent sequence of operations or similar processing leading to a desired result. In this context, operations or processing involve physical manipulation of physical quantities. Typically, although not necessarily, such physical quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like, refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

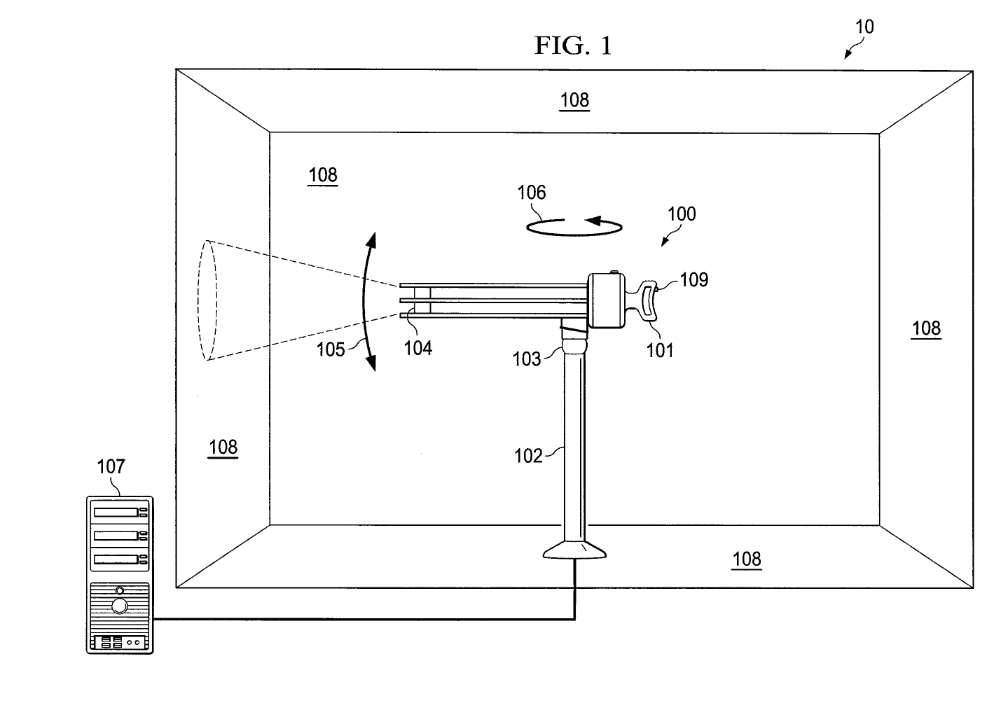

Turning now to FIG. 1, a block diagram illustrates projector-based game system 10 configured according to one embodiment of the present disclosure. Projector-based game system 10 includes controller assembly 100, which is made up of pillar 102, multi-directional hinge 103, and user control device 101 with projector 104 embedded therein. Projector 104 may comprise any method of projection a video image, including, but not limited to, high or medium definition projectors using various technologies, such as light-emitting diode (LED), laser, liquid crystal display (LCD), Texas Instrument's DIGITAL LIGHT PROCESSING™ (DLP™), or the like. Multi-directional hinge 103 allows user control device 101 to move in 360 degrees, direction 106, about pillar 102 and also pitched up and down, direction 105. Multi-directional hinge 103 includes electronic or electrical sensors (not shown) that measure various types of location attributes of user control device 101, such as the rotational movement and pitch of user control device 101. Such electronic or electrical sensors embedded within various types of hinges or pivot points are well known in the art for tracking the motion of the hinge or pivot point. Controller assembly 100 is coupled to computing device 107. Computing device 107 contains the gaming logic that defines and displays the game scenes and game action to a user. Computing device 107 receives the location attributes from multi-directional hinge 103, which are detected based on a user's manipulation of user control device 101, and any activation input signals based on the user's activation of trigger 109. Based on this user input, computing device 107 processes the gaming logic to calculate the next state of the game in an interactive, fully-programmed digital world and presents the resulting game animation of that world for projection at projector 104. Projector 104 projects the game animation onto any section or portion of display surfaces 108 at which it is aiming. The location of such game animation is determined by the direction and orientation that the user has placed on user control device 101.

It should be noted that in the various embodiments of the present disclosure, the projection of the game animation may be configured in various visual formats, such as two-dimensional, three-dimensional, or the like. The different embodiments of the present disclosure are not limited to any particular display format. A game developer may simply make design choices, such as for the projector, animation code development, and the like in order to implement the selected visual format.

It should further be noted that during operation of projector-based game system 10 consideration should be given to the lighting used in the location within display surfaces 108. Because the game animation is being projected from projector 104 of user control device 101, brighter lighting may affect the quality of the display of the animation on any of display surfaces 108. Moreover, the intensity of the projector used in projector 104 will also be a consideration. If a particular game will likely be played in brighter conditions, projector 104 may be selected to have a higher intensity. While the described embodiment of the present disclosure is not limited to any particular lighting level or projector power, selection of the lighting level and projector power may improve the user experience.

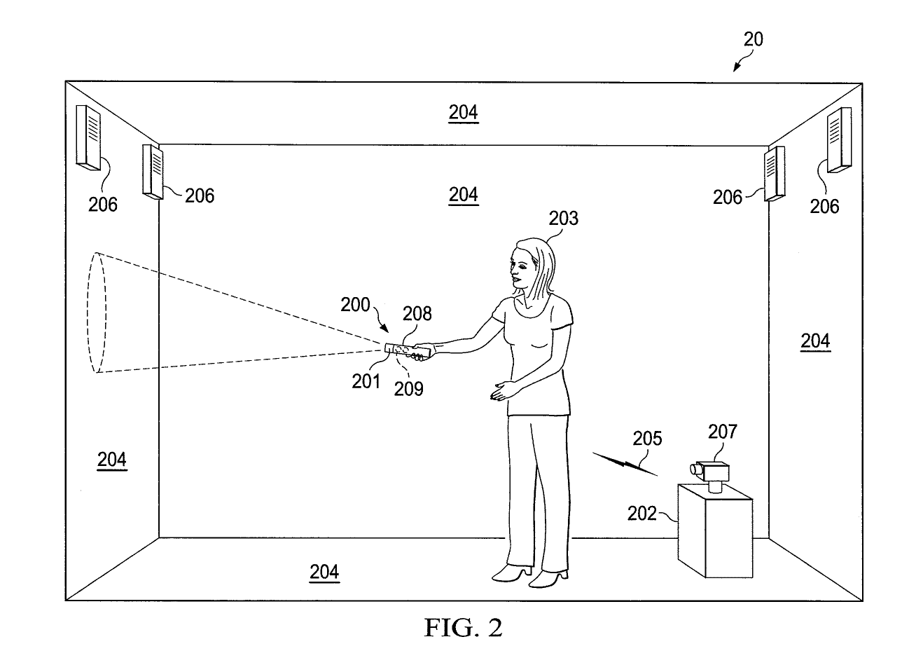

FIG. 2 is a block diagram illustrating projector game system 20 configured according to one embodiment of the present disclosure. Game controller 200 includes projector 201 embedded therein for projecting the game images and game animation of a game executed on game console 202. Game controller 200 is wirelessly coupled to game console 202 through wireless link 205 and transmits any user input and location attributes, such as position information, orientation information, and the like, to game console 202. Position and orientation information may be determined with inertial sensor 208 within game controller 200. Inertial sensor 208 may comprise one or a combination of different inertial sensor types, including gyroscopes, accelerometers, magnetic positioning, and the like. Inertial sensor 208 senses the actual movement, pointing direction, and orientation that user 203 imparts onto game controller 200 and transmits these location attributes to game console 202 for processing and translation into game-related input which is then used to calculate the next game state of the game images and animations for projection via projector 201.

Projector 201 projects the game images and animations onto any of projection surfaces 204, depending on the location at which user 203 is aiming game controller 200. During game play, game console 202 not only computes game images and animations for projection by projector 201 of game controller 200, it also provides additional sensory output to enhance the experience of user 203. For example, game console 202 transmits sound related to the game play and game animations, which is played on speakers 206. Sounds may include an underlying musical soundtrack, game-related sounds, or positioning sounds, such as scratching, footsteps, opening doors, and the like, so that the user is prompted to turn in the direction of the sounds to “see” what is happening in the game environment by pointing game controller 200 in the perceived direction of the sound. In game environments in which the user is perceived to be in a dark setting, projector 201 would display an image that would be similar to what the user would see if they were pointing a flashlight or torch in that direction within the created interactive world that is programmed into game console 202. Additionally, game console 202 transmits data to game controller 200 that triggers activation of haptic motor 209. Haptic motor 209 causes game controller 200 to exhibit a physical action that is physically perceived through the touch of user 203. For example, activation of haptic motor 209 may cause game controller to vibrate, rattle, swerve, of the like. This sensation is felt by user 203 and increases the connection to the game environment. Additional possible methods or features that may be used to improve and heighten the experience include, but are not limited to using sensory data, such as smells (olfactory information), liquid sprays, misters, squirters, smoke, physical motion, physical effects, audio effects, and the like. The various embodiments of the present invention are not limited to any particular type or combination of methods or features.

It should be noted that in various embodiments of the present disclosure, the gaming environment selected is based purely on the imagination of the game developer. Games may be developed in which a dark environment is created, such that the aiming point of game controller 200 reveals the game content that would be seen by shining a flashlight or torch in that direction of the game environment, as noted above. Additional game embodiments may provide a daytime light environment where the aiming point of game controller 200 simulates what would be seen at that point through and x-ray or fluoroscope, an infrared heat sensor, magnified images through a telescope, and the like. The various embodiments of the present disclosure are not limited in any way to the type of game content. Multiple different types of games may be adapted to the various embodiments of the present disclosure.

It should be noted that in additional or alternative embodiments of the present disclosure, game console 202 may also incorporate camera 207. Camera 207 captures additional location attributes, such as images of user 203 and game controller 200 and transmits these images to game console 202 for location analysis. Game console 202 analyzes the captured images to assist in determining motion, orientation, and position of user 203 and game controller 200 that will be used as location attribute input to the game logic executing on game console 202.

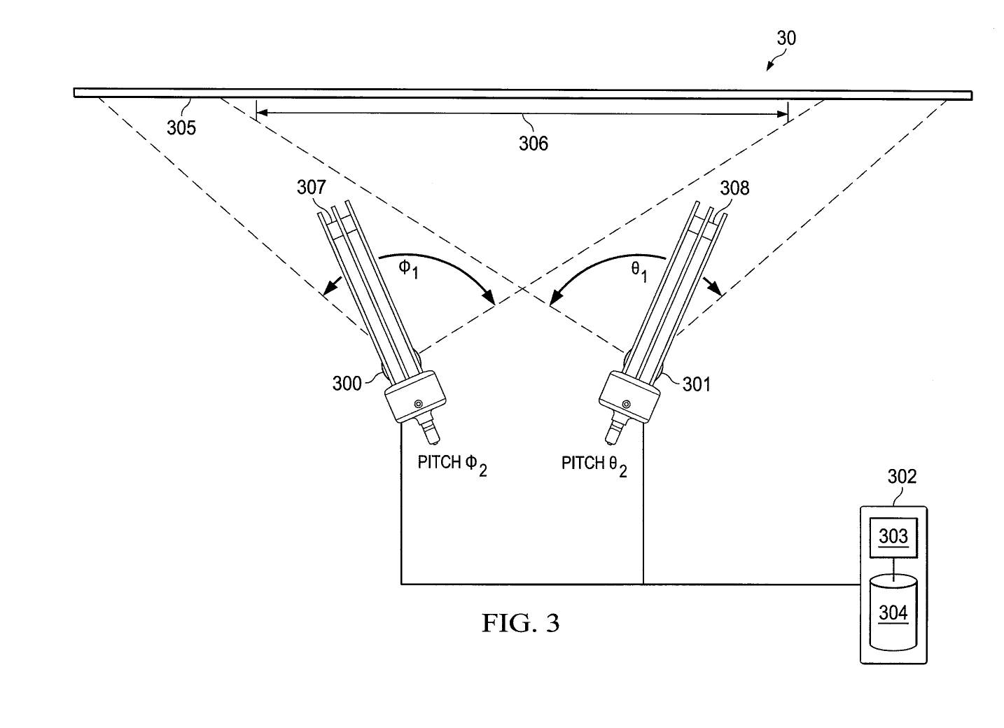

FIG. 3 is a block diagram illustrating amusement game 30 configured according to one embodiment of the present disclosure. Amusement game 30 includes two user control devices 300 and 301 each coupled to computing device 302. User control devices 300 and 301 have projectors 307 and 308 for projecting game-related images and animations onto display screen 305. In this embodiment, display screen 305 is illustrated as a flat surface. It should be noted that display screen 305 may comprise any usable shape, such as curved, circular, dimpled, and the like. Computing device 302 has processor 303 and, coupled thereto, memory 304 for storing game logic. When amusement game 30 is activated, processor 303 executes the game logic stored in memory 304.

Each of user control devices 300 and 301 are fixed at a given location in front of display screen 305. User control devices 300 and 301 are each allowed to rotate in a horizontal plane in a restricted radius of Φ₁ and θ₁, respectively, and a vertical pitch in a restricted radius of Φ₂ and θ₂, respectively. Electronic sensors (not shown) within the structure of user control devices 300 and 301 generate electrical signals representing location attributes, such as the positional movement, and activation of control buttons (not shown) of user control devices 300 and 301. Based on the input of the electrical signals of user control devices 300 and 301, computing device 302 calculates the game animations separately for each of user control devices 300 and 301. These separate game animations correspond to the perspective of each of user control device 300 or 301 of the same game environment. Because of the rotational range of user control devices 300 and 301, the animations that each projects may overlap in overlap zone 306 on display screen 305. Depending on the specific location attributes of user control devices 300 and 301 within overlap zone 306, the animations projected by projectors 307 and 308 may either be different or contain at least partially the same animation objects. Computing device 302 generates the appropriate animations to be projected by projectors 307 and 308 in such overlap zone 306, such that the game players will experience a seamless reveal of their expected perspective of the created game environment.

It should be noted that in alternative embodiments of the present disclosure, when projectors 307 and 308 would be projecting the same animation objects within overlap zone 306, computing device 302 may transmit the separate game animations to user control devices 300 and 301, such that only one of projectors 307 and 308 will project the particular animation object that would be viewed from the perspective of both of user control devices 300 and 301. Providing a single animation projection of the same animation object may minimize the effect of the projected images not matching up exactly due to various signal delays or geometric variations of the positioning of user control devices 300 and 301.

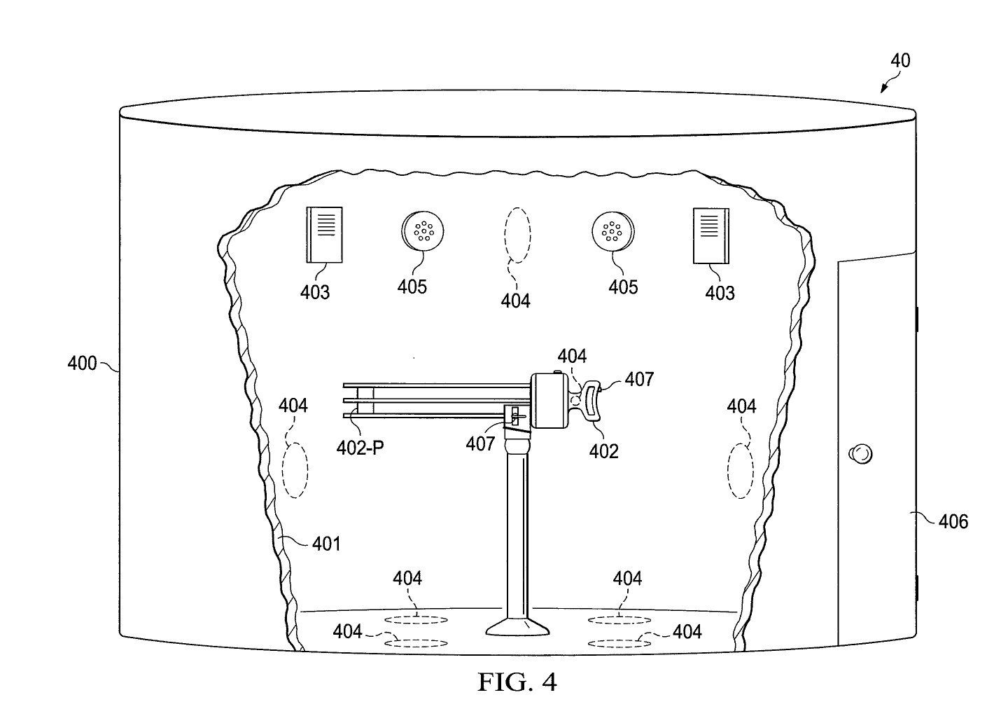

FIG. 4 is a block diagram illustrating amusement game 40 configured according to one embodiment of the present disclosure. Amusement game 40 includes game cabinet 400 configured as a self-contained room large enough for a player to enter amusement game 40 through door 406 and play within a completely enclosed area. A cut-away of game cabinet 400 illustrates thickness 401 in the walls. Thickness 401 provides acoustic dampening, such that a player inside of game cabinet 400 will be at least partially acoustically isolated from sounds outside of game cabinet 400. Thickness 401 may be provided by the thickness of the wall material, insulation inserted between wall material, acoustic insulation, or the like. Game controller 402, with integrated projector 402-P, is located within game cabinet 400. Projector 402-P projects the game animations onto the interior walls of game cabinet 400. The interior walls may be specially coated or have special material affixed that optimizes the display from projector 402-P.

A game processor (not shown) receives game input from the user manipulating game controller 402. Game input may include user input detected through actuation of various switches 407 on game controller 402 as well as location attributes detected through the rotation and pitch changes of game controller 402. Based on this game input, the game processor determines the next game animation states and transmits the visual data to game controller 402 for projection by projector 402-P. In addition to the visual data, the game processor transmits audio information to play through speakers 403 and haptic information to activate haptic device 404 within game controller 402. As such, the user experiences an immersion into the gaming environment through multiple senses.

It should be noted that in alternative embodiments of the present disclosure, haptic devices 404 may also be embedded into the floor and walls of game cabinet 400 in order to increase the physical perception of the game environment. Similar alternative embodiments may include mechanisms to move a platform that the user stands on or other such sensory devices in order to enhance the user's perception of the game environment. Moreover, various additional alternative embodiments may use differently-shaped rooms for game cabinet 400, such as semi-spherical, spherical, vehicle-shaped, and the like. The various embodiments of the present invention are not limited to any particularly-shaped rooms for game cabinet 400.

It should further be noted that in additional alternative embodiments, the interior of game cabinet 400 may be configured to provide a sensory deprivation experience to the user, such that the user's perception of the game environment is enhanced. In such embodiments, active sound dampers 405 may provide active sound cancellation for various background sounds coming from mechanisms within game cabinet 400 or possibly any white noise originating outside of game cabinet 400 that remains after passing through the acoustic dampening affect of thickness 401. Moreover, the interior walls of game cabinet 400 may be treated in order to maximize the darkness within game cabinet 400. Various other sensory deprivation techniques may also be applied which create a heightened sensitivity or awareness of the user while playing amusement game 40 within game cabinet 400.

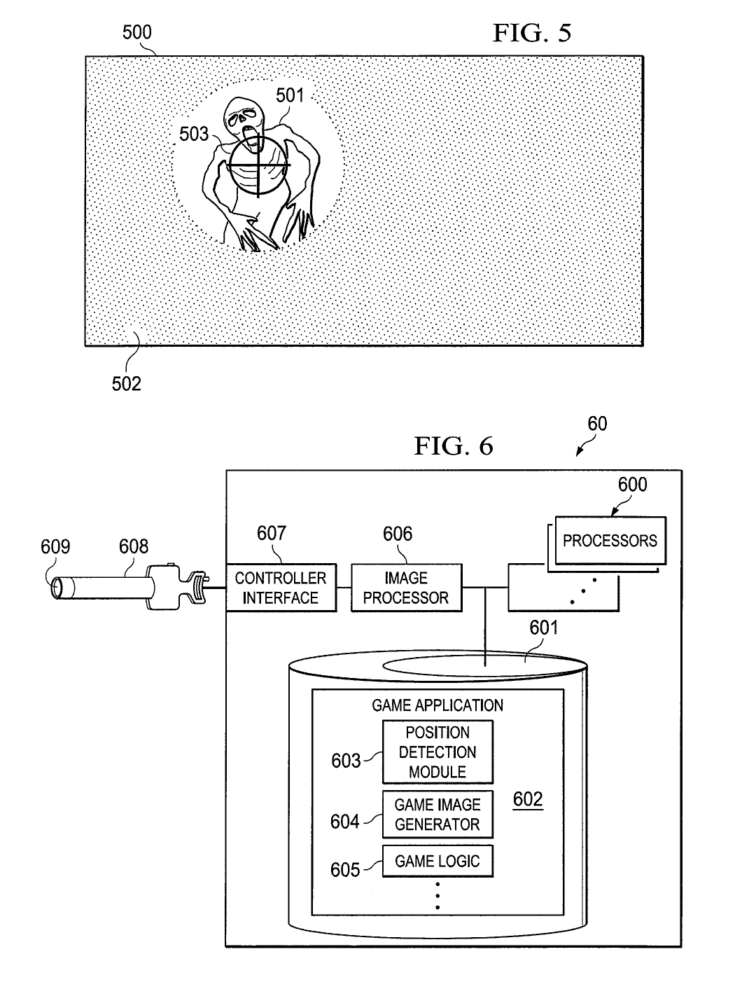

FIG. 5 is a block diagram illustrating display screen 500 displaying animation 501 of a projector-based game configured according to one embodiment of the present disclosure. When the projector portion of a user control device of a projector-based game projects animation 501 of the underlying game play, animation 501 is presented in a circular area on display screen 500. Remaining area 502 of display screen 500 will not be illuminated by the projector and will appear according to the general lighting of the game area. For example, when such a projector-based game is played in a completely dark room, remaining area 502 will appear to the user to be completely dark. Animation 501 will appear as if the user is shining a flashlight or torch in a particular direction in the created game environment. Animation 501 will, thus, appear as the illuminated portion of this created game environment. The objects presented within animation 501 will correspond to that portion of the created game environment at which the user is aiming the flashlight. In the particular game implementation illustrated in FIG. 5, crosshairs 503 are illustrated within animation 501 as an aiming point aid for the user. Because it represents the aiming point of the user controller, crosshairs 503 will remain animated at the center of the viewport represented by animation 501. Other game objects presented within animation 501 may move across the viewport depending on the logic of the underlying game and the characteristics of the game object. The game processor running the game will, therefore, use the location attributes obtained from the game controller with the embedded projector to render that portion of the created game environment that would be illuminated. As the user moves the game controller, it appears as if the flashlight is illuminating different parts of the created interactive game environment. The game processor keeps track of the entire game environment, as it is affected by the user interaction, and transmits the corresponding visual information for projection.

It should be noted that in alternative and/or additional embodiments of the present disclosure the shape of the projected image is not restricted to a circular shape. While the circular shape is illustrated in FIG. 5, it is merely one example of the shapes that may be employed. Any different shape that a projector is capable of projecting may be used by the various embodiments of the present disclosure.

FIG. 6 is a block diagram illustrating computing device 60 configured according to one embodiment of the present disclosure. Computing device 60 includes one or more processors 600 coupled to memory 601. Game application 602 is stored on memory 601 and, when executed by processors 600, provides the visual images and animations for presenting an interactive gaming environment to a user through projector 609 of game controller 608. Computing device 60 further includes image processor 606 for processing the visual images and animations, and controller interface 607 which communicates the processed visual images and animations to game controller 608 for projection through projector 609.

Operation of the gaming environment through execution of game application 602 executes a number of software modules within game application 602. Game logic 605 is executed by processors 600 to determine game play based on the programmed game environment and game input received from game controller 608. The location attribute input signals received from game controller 608 are interpreted by execution of position detection module 603. The game state resulting from the game input, including the interpreted location attribute input signals from location attribute detection module, into game logic 605 is then converted into visual images and animations through execution of game image generator 604 by processors 600. These visual images and animations are processed at image processor 606 and then transmitted to game controller through controller interface 607. The transmitted images are then displayed to a user through projector 609 embedded in game controller 608.

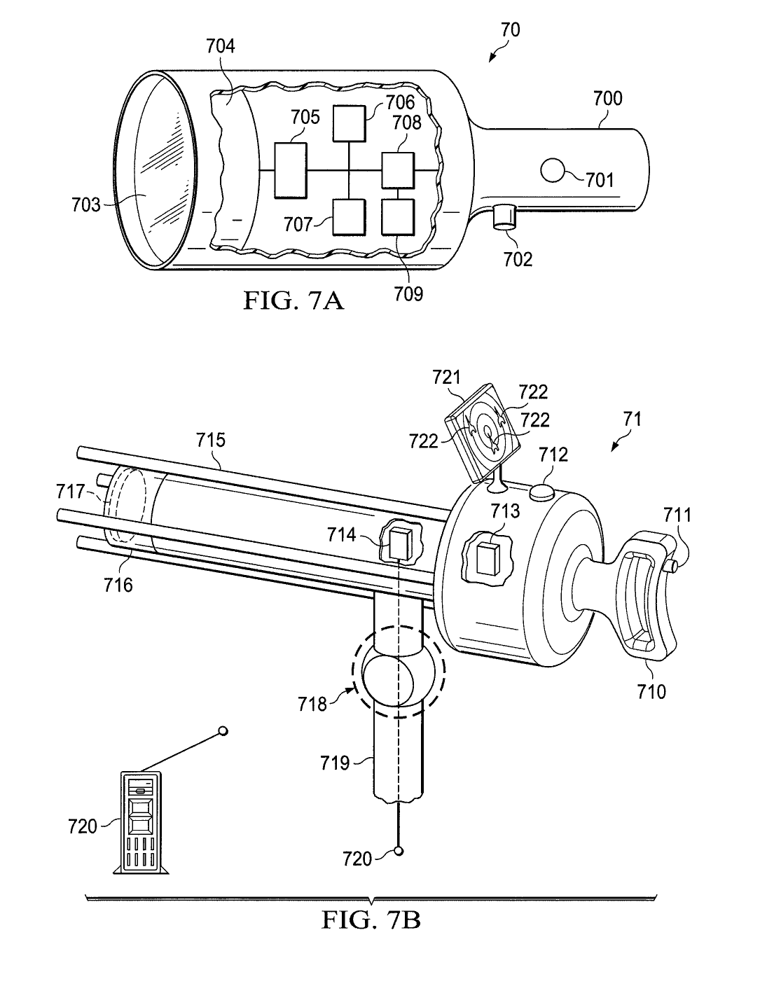

FIG. 7A is a block diagram illustrating user controller 70 configured according to one embodiment of the present disclosure. User controller 70 includes handle 700, which the user may grip when playing a projector-based amusement game. Buttons 701 and 702 are accessible to the user on handle 700 and may be used according to the particular functionality of the underlying game. The visual images and animation of the game are projected by projector 704 through lens 703 onto a physical display screen (not shown). The image and animations are fed into projector 704 through video driver 705, which receives the images from processor 708. The images and animations are originally generated at a computing device (not shown) and wirelessly transmitted from the computing device to user controller 70 via wireless antenna 709. Additional features, such as inertial sensor 706 and positional detector 707, detect and provide location attributes, such as orientation and positional data, that are transmitted through wireless antenna 709 to the computing device. Positional detector 707 may be a component part of various position detecting systems, such as electronic positioning systems, magnetic positioning systems, radio frequency positioning systems, infrared or laser positioning systems, global positioning satellite (GPS) receivers, and the like, or even any combination of such systems. The information detected from such inertial sensor 706 and positional detector 707 are used either separately or in combination to determine the location attributes of user controller 70. The computing device uses these location attributes, as well as any signals indicating user actuation of buttons 701 and 702, as input when calculating and determining the next states of the game and their corresponding images and animations. These new images and animations are then transmitted to the user controller 70 for projection of the changing game environment through projector 704.

FIG. 7B is a block diagram illustrating user controller 71 configured according to one embodiment of the present disclosure. User controller 71 includes handle 710, which the user may grip when playing the corresponding projector-based amusement game. Trigger 711, on handle 710, and button 712 allow a user to activate various features of the game environment. Haptic motor 713 is located on the interior of the housing of user controller 71. Based on signals received from gaming computer 720, haptic motor will cause physical sensations to be propagated through user controller 71 and handle 710 in order to provide the user with an enhanced experience with the game environment. Visual display 721 is a small visual screen that displays various information related to the underlying projector-based game. For example, in the embodiment illustrated in FIG. 7B, visual display 721 is configured as a radar screen displaying game targets 722 to the user. Video driver 714 receives the game images and animations from gaming computer 720 and drives projector 716 to project the images and animations through lens 717 onto some kind of display screen to be viewed by the user. User controller 71 may include various decorative features, such as decorative feature 715, which also enhances the user experience.

User controller 71 is placed in a fixed location attached to pillar 719. While fixed in one location, detector hinge assembly 718 allows a user to change the positioning of user controller 71 by rotating it 360 degrees in the horizontal plane while changing the vertical pitch by a particular range. Electronic or electrical sensors within user controller 71 detect these location attributes, such as position, orientation, and movement of user controller 71, and sends such signals to gaming computer 720 as input for determining the next state of the game. Gaming computer 720 uses this position- and movement-related input in addition to any input received based on the user's activation of trigger 711 or button 712 to calculate the next game states. Gaming computer 720 then generates the game images and animations corresponding to those next game states and sends the visual information to video driver 714 to send the images and animations for projection by projector 716. Gaming computer 720 also uses the next game states to send supplemental visual information to the user through visual display 721. Representing a radar screen, the supplemental information displayed on visual display 721 represents locations of game targets 722 that may or may not be visible to the user through the viewport of the projected image. As the game states change, game targets 722 will also move to different locations on the radar screen of visual display 721. This supplemental information would assist the user in pointing controller 71 in a productive direction associated with the game play. Thus, the user manipulates user controller 71 and, based on those manipulations, sees the changing game environment as projected by projector 716 and as displayed by visual display 721 of user controller 71.

It should be noted that various projector-based games configured according to different embodiments of the present disclosure may utilize various types or shapes of user controllers. Such games may use fixed controllers, such as user controller 71, wireless controllers, such as user controller 70, or a combination of such controllers for use in multi-player games. The various embodiments of the present disclosure are not limited to use of only one type of projector-embedded controller.

It should further be noted that in additional embodiments of the present disclosure, the user provides input by manipulating the game controllers. However, the game itself is displayed by a number of fixed projectors that are a part of the game environment and not a part of the game controller.

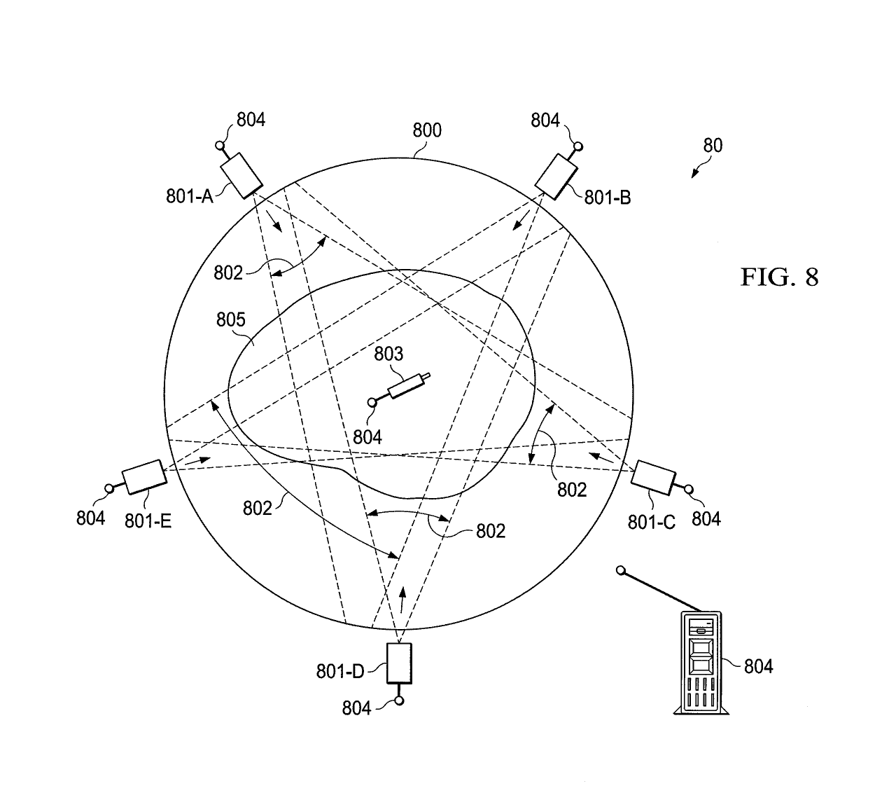

FIG. 8 is a block diagram illustrating a top-down view of projector-based game 80 configured according to one embodiment of the present disclosure. Projector-based game 80 is played within game cabinet 800. Similar to game cabinet 400 (FIG. 4), game cabinet 800 may be completely enclosed with interior walls able to act as projection screens. Game cabinet 800 includes game stage 805, across which a user playing projector-based game 80 may freely move during game play. In the illustrated embodiment, the game environment is displayed to a user by a combination of five projectors, projectors 801-A-801-E. Each of projectors 801-A-801-E has a projection radius, projection radii 802, within which it may visibly project game images and animations onto the walls of game cabinet 800, which may be curved, spherical, semi-spherical, or the like. With regard to the example embodiment described in FIG. 8, projection radii 802 are configured such that the projection areas of some of projectors 801-A-801-E will either just slightly overlap or are adjusted to join projection edges in order to potentially make a full 360 degree projected image without any gaps between projection points.

User controller 803 is not fixed to a certain location within game cabinet 800 which allows the user to freely move it across game stage 805, holding it in various directions and positions in relation to the interior of game cabinet 800. The location attributes, for example, the location on game stage 805, the height within game cabinet 800, the orientation of user controller 803, the aiming point of user controller 803, and the like, are detected by inertial and positional sensors (not shown) embedded within user controller 803, which may operate independently, or in combination with sensor located around game cabinet 800. User controller 803 also provides for buttons or triggers (not shown) for the user to select to perform some game-related function. These location attributes are then transmitted to gaming computer 804 along with any detected button or trigger signals. Gaming computer 804 uses this input data to determine the next states of the game.

Gaming computer 804 also generates the various images and animations associated with those next states of the game for presentation to the user through various combinations of projectors 801-A-801-E. For example, projectors 801-A-801-E may project standard background images all around the projection surfaces on the interior walls of game cabinet 800. As game-associated actions take place, additional animation objects that are associated with the game actions may be generated by gaming computer 804 and projected by any combination of projectors 801-A-801-E over the background images. Gaming computer 804 generates the specific animation objects associated with the location that the user is aiming game controller 803 and signals the particular one or more of projectors 801-A-801-E to project the animation object or objects according to the progression of the game environment associated with the user's aiming point, as calculated based on the location attributes and any detected button or trigger signals received from user controller 803. Gaming computer 804 would also generate and signal the appropriate ones of projectors 801-A-801-E to project additional game animations that may be associated with the animation object or objects projected based on the aiming point of user controller 803. For example, in a first non-limiting example of game content to be implemented with projector-based game 80, the game environment is a dark environment in which zombies are approaching to attack the user holding user controller 803. The aiming point of user controller 803 reveals a section of the created and programmed game environment that would be seen if the user were shining a flashlight or torch in that particular direction. Gaming computer 804 generates the images for projection in that revealed portion of the game environment. If a zombie is animated in this revealed portion, the user would elect to activate a trigger on user controller 803, which prompts gaming computer 804 to animate some kind of shooting (e.g., bullets, laser blasts, electricity bolts, and the like). The animation of this shooting may cause secondary images within the dark environment to be illuminated even though they do not reside within the aiming point projection area. For instance, a muzzle blast from user controller 803 representation of a weapon may illuminate areas in the immediate game environment vicinity of user controller 803. The illuminated areas would be represented by additional animation objects or visual elements generated by gaming computer 804 and projected by an appropriate one or more of projectors 801-A-801-E. Alternatively, animated shooting of tracer rounds, may also cause illumination of areas not within the aiming point projection area, or ricochet sparks, blast impacts, and the like, may cause secondary animations to be generated by gaming computer 804 and projected independently of the aiming point projection area. Additionally, programmed environmental conditions may also reveal new animations that are independent from the animation objects of the aiming point projection area. In such a dark environment, a bolt of lightening may reveal multiple new animations outside of the aiming point projection area.

The resulting images, including the animation objects of the aiming point projection area and any other secondary animations, whether related to or independent from the aiming point projection area animations, would be displayed to the user at the particular locations in the created game environment. This immersive environment would allow games to be developed that place the user into a new virtual interactive world with various game-related activities being projected based on the user's movement and manipulation of user controller 803.

For example, one embodiment of such an immersive game might place the user in a forest. The background images and animations may be the grass or trees, while game-related action may be fairies flying around that are created and programmed to be invisible to the naked eye, but visible through the use of a simulated infrared heat detector. User controller 803 represents a net catapult with an infrared detector attached to it, such that as the user moves the aiming point of user controller 803, gaming computer 804 animates an aiming point animation that represents an infrared display superimposed onto the background forest scene. As the user sees the heat signature of a fairy within the aiming point animation, he or she may trigger release of a net to capture the fairy. This net catapulting process would then be animated by gaming computer 804 and projected onto the interior walls of game cabinet 800 by the appropriate one or more of projectors 801-A-801-E, in the process as described above.

Another embodiment of such an immersive game might be a futuristic city environment, in which the background images and animations would be the city landscape with buildings, vehicles, people, and the like. The game-related action might be terrorists attacking the city. User controller 803 may represent a weapon of some sort with a high-powered telescope. The user looks at the city landscape during operation of the game attempting to find the terrorists. When the user spies a person who may look like a terrorist, he or she may activate the telescope by depressing a button on user controller 803. By activating this button, gaming computer 804 would begin generating animation objects that represent the magnified view of the aiming point of user controller 803 through the high-powered telescope. The user would then manipulate user controller 803 in such a manner to identify, with the magnified perception of the aiming point animation, whether the person is a terrorist and, if so, electing to shoot the terrorist with the simulated weapon represented by user controller 803.

In still further embodiments of such immersive games, projector-based game 80 may be linked with multiple units using a local area network (LAN), wide area network (WAN), such as the Internet, cell phone voice/data networks, and the like. Each player in such a linked game unit would be a part of the gaming environment. As the user of projector-based game 80 plays the game, he or she may see animated representations of other players within the game environment, as projected by projectors 801-A-801-E. Gaming computer 804 would receive position and game state information from the user controllers being operated by the other players in the linked game units and generate the entire game environment using all of the location attributes received from each player. The players may also be able to interact with one another at various levels whether through game play, through audible communication between game units, and the like.

It should be noted that any number of different game concepts could be adapted to the various embodiments of projector-based amusement games of the present disclosure. The various embodiments of the present disclosure are not limited in any way based on game content.

It should further be noted that the display environment is not in anyway limited to enclosed game cabinets, such as game cabinet 800, or any specific type of screen or projection implementations. In additional or alternative embodiments, any shape or type of projection surface could be used in combination with various projection systems that utilize one or many projectors. For example, in addition to projection screens, the images and animations may be projected onto any number of different projection surfaces, such as glass, water, smoke, or any variety of flat or shaped surfaces. Various embodiments of the present disclosure may also be implemented in large-scaled environments using large-scaled projection systems, such as IMAX Corporation's IMAX® projection standard, in flat or spherical/semi-spherical implementations, such as IMAX Corporation's IMAX Dome®/OMNIMAX®, and the like. The various embodiments of the present disclosure are not limited in scope to any particular type of screen or projection system.

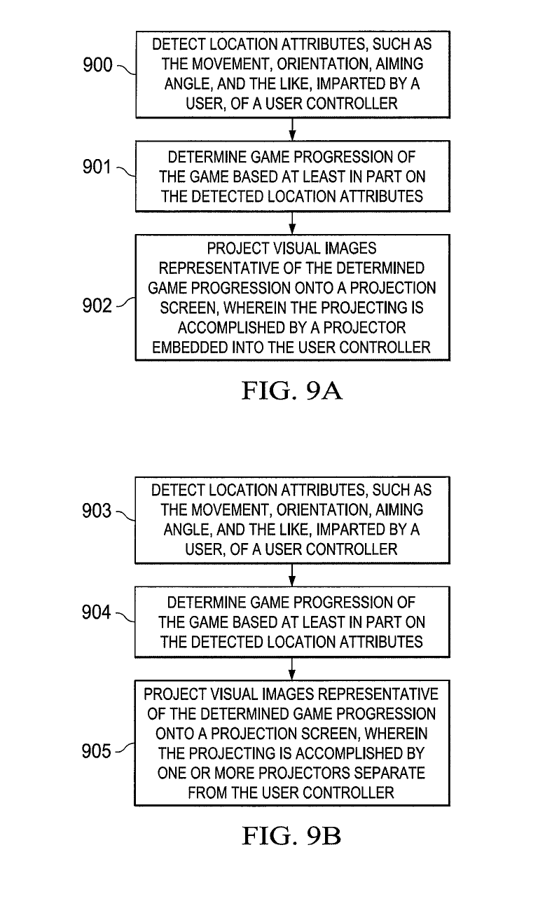

FIG. 9A is a functional block diagram illustrating example blocks executed to implement one embodiment of the present disclosure. In block 900, location attributes, such as the movement, orientation, aiming angle, and the like, imparted by a user, of a user controller are detected. Game progression of the amusement game is determined, in block 901, based at least in part on the detected location attributes. Visual images are projected, in block 902, representative of the determined game progression onto a projection screen, wherein the projecting is accomplished by a projector embedded into the user controller.

FIG. 9B is a functional block diagram illustrating example blocks executed to implement one embodiment of the present disclosure. In block 903, location attributes, such as the movement, orientation, aiming point, and the like, imparted by a user, of a user controller are detected. Game progression of the amusement game is determined, in block 904, based at least in part on the detected location attributes. Visual images representing the game progression at the aiming point of the user controller are projected, in block 905 by one or more projectors separate from the user controller.

It should be noted that in alternative embodiments of the present disclosure, the user controller comprises multiple separate physical elements. The different physical elements of the user controller may operate either in coordination or separately for providing input to the executing game logic. The gaming computer would generate various game-related animations based on the input from both physical elements of the game controller.

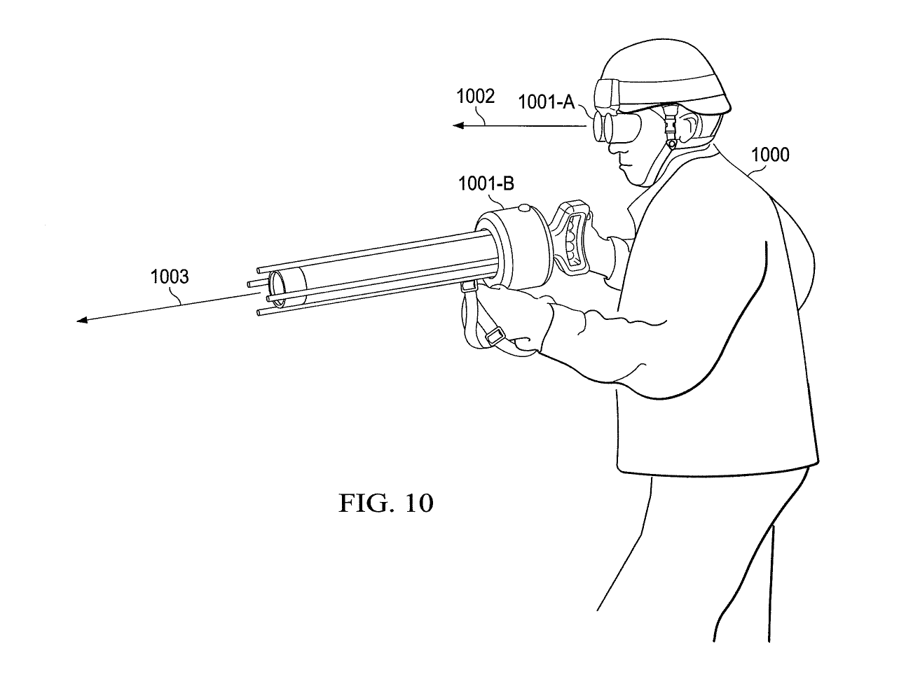

FIG. 10 is a block diagram illustrating user controllers 1001-A and 1001-B configured in a projector-based game according to one embodiment of the present disclosure. The user controls provided in the projector-based game described with respect to FIG. 10 are divided into two separate physical elements, user controller 1001-A and user controller 1001-B. User controller 1001-A is configured as a head-piece worn by user 1000. User controller 1001-B is configured as a weapon held by user 1000. In operation, inertial and positional sensors within user controller 1001-A (not shown) detect location attributes, such as where user 1000 is looking (direction 1002) within the projection of the animated game environment. Using these location attributes, the game computer executing the projector-based game generates the animation objects representing the portions of the game environment where user 1000 is looking. One example of the game content of this projector-based game may be user 1000 wearing night vision goggles, represented by user controller 1001-A, and carrying a weapon, represented by user controller 1001-B.

As user 1000 sees a target show up in the looking point projection area, he or she may aim user controller 1001-B at the target and activate a trigger (not shown) to shoot at the target. Sensors embedded within user controller 1001-B (not shown) detect the location aspects, including the aiming point, of user controller 1001-B. The game computer executing the projector-based game would then generate a new animation that would include the looking point animation, based on the location attributes of user controller 1001-A, and an aiming point animation, based on the location attributes of user controller 1001-B, in addition to any secondary animations within the created game environment that may arise in response to the context animations of the shooting or any other programmed environmental influence.

As the game computer executing the described projector-based game is executing the game states and environment of the entire game, the animations of the looking point projection areas and aiming point projection areas may operate independently from one another. For example, within the context of the game play, user 1000 sees a target within the looking point projection area, but also, as a part of the audio output of the game, hears running footsteps in an area outside of the looking point projection area. User 1000 begins moving and aiming user controller 1001-B in the direction (direction 1003) of the target sighted within the looking point projection area, but also simultaneously begins changing his or her gaze in the direction of the running footsteps. User 1000 pulls the trigger to shoot in the direction of the previously viewed target, which is no longer projected and, thus, is no longer visible to user 1000 within the looking point projection area. The game computer then determines the next gaming states based on the location attributes of user controller 1001-B and generates an aiming point animation which projects tracer shots being fired in the direction of the previously viewed target. The tracer bullet animations may provide illumination of this previously viewed target, while the new looking point animation generated by the game computer is projecting in a different area and displays to user 1000 the next game states of viewing the target source of the footsteps heard by user 1000 in the looking point projection area. In such an embodiment, user 1000 is interacting with multiple points in the created game environment, including points which are not immediately viewable by user 1000. This provides a much more realistic experience for user 1000 being immersed within the interactive created game environment.

It should be noted that in additional and/or alternative embodiments of the present disclosure, even more than two devices may be used in combination for a user controller. One device may represent a weapon, another device could represent an infrared heat detector, while another device may provide a view of the direction that the user is looking or even a direction that the user is not looking. Various configurations of multiple devices may be selected based on the game content to implement the user controller in any particular projector-based game configured according to the present disclosure.

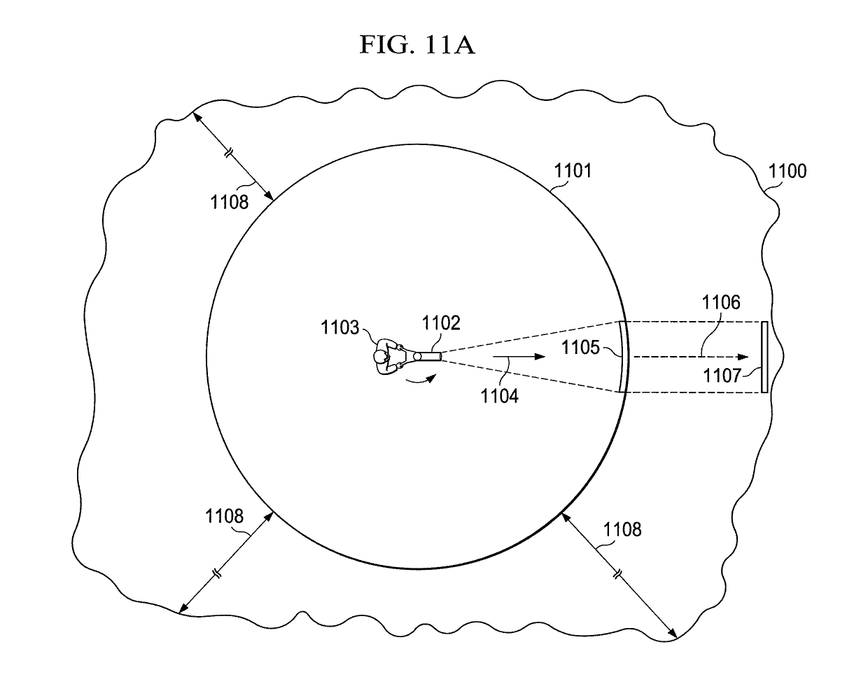

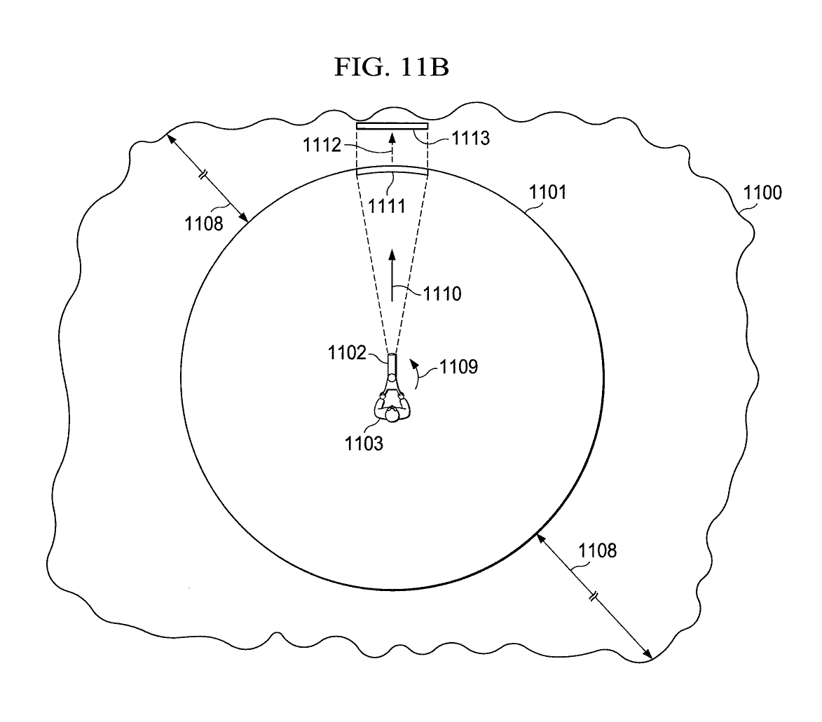

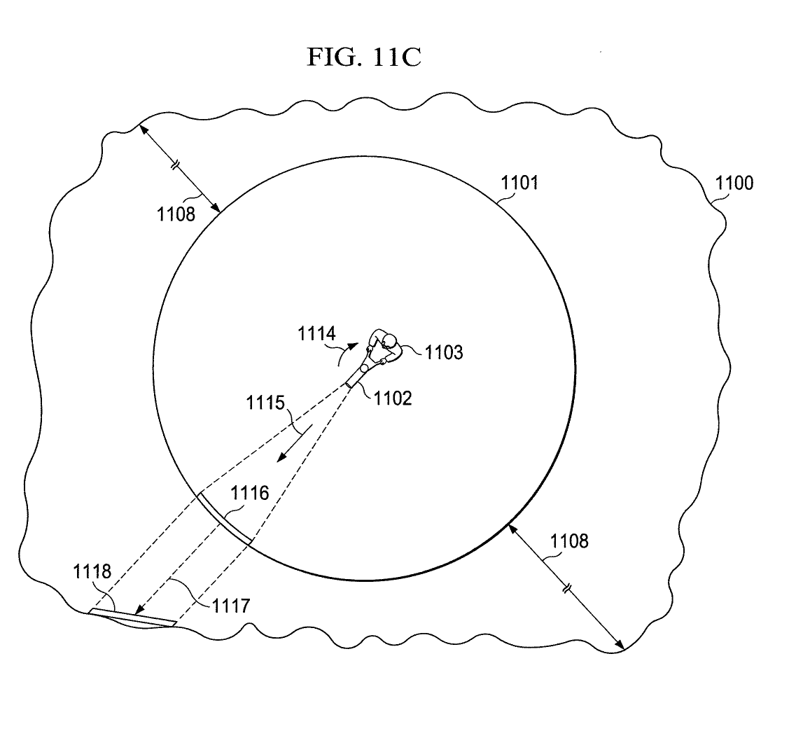

FIGS. 11A-11C are conceptual block diagrams illustrating a sequence of time during game play of a projector-based game configured according to one embodiment of the present disclosure. In FIG. 11A, the projector-based game defines a created, programmed world within which the prospective players will be immersed for game play. This created world is conceptually represented by game world 1100. Game world 1100 is the created world that is being processed and projected through the projector-based game. In the real world, user 1103 is physically within game cabinet 1101. The visual images and animations projected to user 1103 make user 1103 believe that he or she is actually within game world 1100. Thus, virtual space 1108 represents the perceived environment within which user 1103 exists in game world 1100 outside the walls of game cabinet 1101.

In operation, user 1103 points and aims user control 1102 in direction 1104. Based on this detected direction, the projector-based game generates visual images and animations that represent game world location 1107 in virtual direction 1106 within game world 1100, giving user 1103 the perception that he or she is seeing beyond the physical walls of game cabinet 1101. However, within the context of the physical game, a projector projects the visual images and animations onto the walls of game cabinet 1101 at projection point 1105.

In continued play of the game in FIG. 11B, user 1103 rotates user control 1102 in rotation direction 1109 in order to aim user control 1102 in direction 1110. Based on the detected movement and location aspects of user control 1102, the projected images and animations appear on projection point 1111 on the physical walls of game cabinet 1101. However, the projected images allow user 1103 to perceive the images and animations of the game environment as if it were game world location 1113 in virtual direction 1112. Here again, user 1103 is immersed in the virtual world of game world 1100 and, based on what is projected at projection point 1111, user 1103 feels like he or she is visualizing a scene within virtual space 1108, beyond the physical walls of game cabinet 1101.

As user 1103 continues play in FIG. 11C, he or she rotates user control 1102 in rotation direction 1114 in order to aim user control 1102 in direction 1115. Based on the detected location attributes of user controller 1102, the projector-based game generates images and animations representing that virtual portion of game world 1100 at game world location 1118 in virtual direction 1117. The projector-based game then projects the images and animations onto the inner walls of game cabinet 1101 at projection point 1116. User 1103 sees the projected images and animations and perceives them to be located in virtual space 1108 outside of game cabinet 1101, as if he or she were actually within the created world programmed into game world 1100. Thus, the operation of the projector-based game provides visualization of the created world programmed into game world 1100 that allows user 1103 to be totally immersed in that created world. Even though user 1103 is physically located within the confines of game cabinet 1101, he or she actually perceives him or herself to be experiencing the game into virtual space 1108, outside of game cabinet 1101.

It should be noted, as previously stated herein, that the example game play described with respect to any of the illustrated embodiments of the present disclosure are not intended to restrict, in any way, the game content or types of games that are adaptable to the various embodiments of the present disclosure.

Embodiments, or portions thereof, may be embodied in program or code segments operable upon a processor-based system (e.g., computer system or computing platform) for performing functions and operations as described herein. The program or code segments making up the various embodiments may be stored in a computer-readable medium, which may comprise any suitable medium for temporarily or permanently storing such code. Examples of the computer-readable medium include such tangible computer-readable media as an electronic memory circuit, a semiconductor memory device, random access memory (RAM), read only memory (ROM), erasable ROM (EROM), flash memory, a magnetic storage device (e.g., floppy diskette), optical storage device (e.g., compact disk (CD), digital versatile disk (DVD), etc.), a hard disk, and the like.

Embodiments, or portions thereof, may be embodied in a computer data signal, which may be in any suitable form for communication over a transmission medium such that it is readable for execution by a functional device (e.g., processor) for performing the operations described herein. The computer data signal may include any binary digital electronic signal that can propagate over a transmission medium such as electronic network channels, optical fibers, air, electromagnetic media, radio frequency (RF) links, and the like, and thus the data signal may be in the form of an electrical signal, optical signal, radio frequency or other wireless communication signal, etc. The code segments may, in certain embodiments, be downloaded via computer networks such as the Internet, an intranet, a local area network (LAN), a metropolitan area network (MAN), a wide area network (WAN), the public switched telephone network (PSTN), a satellite communication system, a cable transmission system, cell phone data/voice networks, and/or the like.

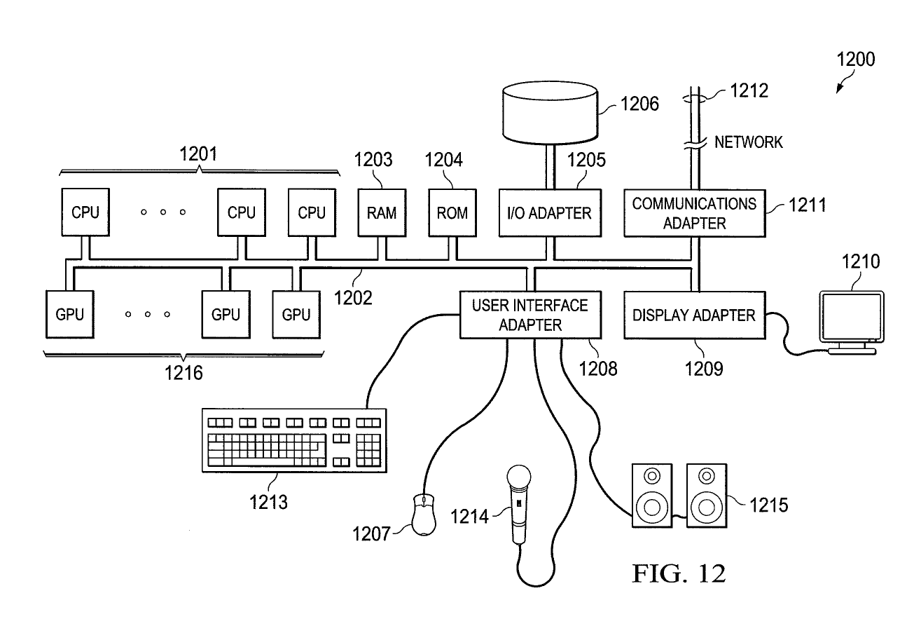

FIG. 12 illustrates exemplary computer system 1200 which may be employed to implement the various aspects and embodiments of the present disclosure. Central processing unit (“CPU” or “processor”) 1201 is coupled to system bus 1202. CPU 1201 may be any general-purpose processor. The present disclosure is not restricted by the architecture of CPU 1201 (or other components of exemplary system 1200) as long as CPU 1201 (and other components of system 1200) supports the inventive operations as described herein. As such CPU 1201 may provide processing to system 1200 through one or more processors or processor cores. CPU 1201 may execute the various logical instructions described herein. For example, CPU 1201 may execute machine-level instructions according to the exemplary operational flow described above in conjunction with FIGS. 9A and 9B and any of the other processes described with respect to illustrated embodiments. When executing instructions representative of the operational steps illustrated in FIGS. 9A and 9B and any of the other processes described with respect to illustrated embodiments, CPU 1201 becomes a special-purpose processor of a special purpose computing platform configured specifically to operate according to the various embodiments of the teachings described herein.

Computer system 1200 also includes random access memory (RAM) 1203, which may be SRAM, DRAM, SDRAM, or the like. Computer system 1200 includes read-only memory (ROM) 1204 which may be PROM, EPROM, EEPROM, or the like. RAM 1203 and ROM 1204 hold user and system data and programs, as is well known in the art.

Computer system 1200 also includes input/output (I/O) adapter 1205, communications adapter 1211, user interface adapter 1208, and display adapter 1209. I/O adapter 1205, user interface adapter 1208, and/or communications adapter 1211 may, in certain embodiments, enable a user to interact with computer system 1200 in order to input information.

I/O adapter 1205 connects to storage device(s) 1206, such as one or more of hard drive, compact disc (CD) drive, floppy disk drive, tape drive, etc., to computer system 1200. The storage devices are utilized in addition to RAM 1203 for the memory requirements of the various embodiments of the present disclosure. Communications adapter 1211 is adapted to couple computer system 1200 to network 1212, which may enable information to be input to and/or output from system 1200 via such network 1212 (e.g., the Internet or other wide-area network, a local-area network, a public or private switched telephony network, a wireless network, any combination of the foregoing). User interface adapter 1208 couples user input devices, such as keyboard 1213, pointing device 1207, and microphone 1214 and/or output devices, such as speaker(s) 1215 to computer system 1200. Display adapter 1209 is driven by CPU 1201 and/or by graphical processing unit (GPU) 1216 to control the display on display device 1210 to, for example, present the results of the simulation. GPU 1216 may be any various number of processors dedicated to graphics processing and, as illustrated, may be made up of one or more individual graphical processors. GPU 1216 processes the graphical instructions and transmits those instructions to display adapter 1209. Display adapter 1209 further transmits those instructions for transforming or manipulating the state of the various numbers of pixels used by display device 1210 to visually present the desired information to a user. Such instructions include instructions for changing state from on to off, setting a particular color, intensity, duration, or the like. Each such instruction makes up the rendering instructions that control how and what is displayed on display device 1210.

It shall be appreciated that the present disclosure is not limited to the architecture of system 1200. For example, any suitable processor-based device or multiple such devices may be utilized for implementing the various embodiments of the present disclosure, including without limitation personal computers, laptop computers, computer workstations, multi-processor servers, and even mobile telephones. Moreover, certain embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for a game, comprising:
detecting one or more location attributes of a user controller imparted on said user controller by a user;
determining game progression of said game based at least in part on said detected one or more location attributes; and
projecting visual images representative of a portion of said determined game progression associated with said one or more location attributes.

2. The method of claim 1 wherein said detecting comprises one or more of:
detecting said movement using one or more rotational detectors coupled to said user controller;
measuring inertial changes in said user controller using one or more inertial sensors embedded in said user controller;
analyzing capture video images of said user controller; and
detecting said movement using wireless positioning data received by a positioning antenna embedded in said user controller.

3. The method of claim 1 wherein said determining comprises:
translating said detected movement into motion data input;
processing game logic with said motion data input;
determining a next game state in response to said processing;
generating said visual images representative of said portion of said next game state; and
transmitting said visual images for said projecting.

4. The method of claim 1 wherein said projecting comprises:
projecting said visual images using one of:
one or more embedded projectors embedded within said user controller; or
one or more external projectors separate from said user controller.

5. The method of claim 1 wherein said user controller comprises a plurality of separate physical elements manipulatable by said user, wherein said one or more location attributes are detected from at least one of said plurality of separate physical elements.

6. The method of claim 1 further comprising:
emitting sensory data associated with said game progression.

7. The method of claim 6 wherein said sensory data comprises one or more of:
haptic information;
audio information;
visual information; and
olfactory information.

8. The method of claim 1 further comprising:
determining supplemental game progression information based at least in part on said detected one or more location attributes; and
displaying a visual representation of said supplemental game progression information to said user.

9. The method of claim 8 wherein said visual representation is displayed through one of:
one or more projectors projecting said visual images; or
said one or more projectors projecting said visual images and a supplemental display on said user controller, wherein said displayed visual representations identify game data one or both of: within a projection area of said one or more projectors and outside of said projection area.

10. A computer program product for a game, comprising:
a computer-readable medium having program code recorded thereon, said program code comprising:
program code to detect one or more location attributes of a user controller imparted on said user controller by a user;
program code to determine game progression of said game based at least in part on said detected one or more location attributes; and
program code to project visual images representative of a portion of said determined game progression associated with said one or more location attributes.

11. The computer program product of claim 10 wherein said program code to detect comprises one or more of:
program code to detect said movement using one or more rotational detectors coupled to said user controller;
program code to measure inertial changes in said user controller using one or more inertial sensors embedded in said user controller;
program code to analyze capture video images of said user controller; and
program code to detect said movement using wireless positioning data received by a positioning antenna embedded in said user controller.

12. The computer program product of claim 10 wherein said program code to determine comprises:
program code to translate said detected movement into motion data input;
program code to process game logic with said motion data input;
program code to determine a next game state in response to said processing;
program code to generate said visual images representative of said portion of said next game state; and
program code to transmit said visual images for input into said program code to project.

13. The computer program product of claim 10 wherein said program code to project comprises:
program code to project said visual images using one of:
one or more embedded projectors embedded within said user controller; or
one or more external projectors separate from said user controller.

14. The computer program product of claim 10 wherein said user controller comprises a plurality of separate physical elements manipulatable by said user, wherein said one or more location attributes are detected from at least one of said plurality of separate physical elements.

15. The computer program product of claim 10 further comprising:
program code to emit sensory data associated with said game progression.

16. The computer program product of claim 15 wherein said sensory data comprises one or more of:
haptic information;
audio information;
visual information; and
olfactory information.

17. The computer program product of claim 10 further comprising:
program code to determine supplemental game progression information based at least in part on said detected one or more location attributes; and
program code to display a visual representation of said supplemental game progression information to said user.

18. The computer program product of claim 17 wherein said visual representation is displayed through one of:
one or more projectors projecting said visual images; or
said one or more projectors projecting said visual images and a supplemental display on said user controller, wherein said displayed visual representations identify game data one or both of: within a projection area of said one or more projectors and outside of said projection area.

19. A game apparatus comprising
at least one processor; and
a memory coupled to said at least one processor,
wherein said at least one processor is configured to:
detect one or more location attributes of a user controller imparted on said user controller by a user, said user controller being at least a part of said game apparatus;
determine game progression of said game based at least in part on said detected one or more location attributes; and
direct projection of visual images representative of a portion of said determined game progression associated with said one or more location attributes.

20. The game apparatus of claim 19 wherein said at least one processor configured to detect comprises configuration to one or more of:
detect said movement using one or more rotational detectors coupled to said user controller;
measure inertial changes in said user controller using one or more inertial sensors embedded in said user controller;
analyze captured video images of one or both of said user controller and said user; and
detect said movement using wireless positioning data received by a positioning antenna embedded in said user controller.

21. The game apparatus of claim 19 wherein said at least one processor configured to determine game progression comprises configuration to:
translate said detected movement into motion data input;
process game logic with said motion data input;
determine a next game state in response to said processing;
generate said visual images representative of said portion of said next game state; and
transmit said visual images to said at least one processor for said configuration to direct projection.

22. The game apparatus of claim 19 further comprising one of:
one or more embedded projectors embedded within said user controller and coupled to said at least one processor; or
one or more external projectors separate from said user controller and in communication with said at least one processor;
wherein said at least one processor configured to direct projection comprises configuration to direct projection of said visual images using said one of: said one or more embedded projectors or said one or more external projectors.

23. The game apparatus of claim 19 wherein said user controller comprises a plurality of separate physical elements manipulatable by said user, wherein said one or more location attributes are detected from at least one of said plurality of separate physical elements.

24. The game apparatus of claim 19 wherein said at least one processor is further configured:
to transmit sensory data associated with said game progression to a sensory data apparatus within perception of said user.

25. The game apparatus of claim 24 wherein said sensory data comprises one or more of:
haptic information;
audio information;
visual information; and
olfactory information.

26. The game apparatus of claim 19 wherein said at least one processor is further configured to:
determine supplemental game progression information based at least in part on said detected one or more location attributes; and
display a visual representation of said supplemental game progression information to said user.

27. The game apparatus of claim 26 further comprising one or both of:
one or more projectors in communication with said at least one processor; and
a supplemental display on said user controller and coupled to said at least one processor;
wherein said visual representation is displayed to said user through one of:
said one or more projectors projecting said visual images; or
said one or more projectors projecting said visual images and said supplemental display, wherein said displayed visual representations identify game data in one or both of: within a projection area of said one or more projectors and outside of said projection area.
